(19) United States
(12) Patent Application Publication
(10) Pub. No.: US 2017/0066145 A1
(43) Pub. Date: Mar. 9, 2017

(54) Knife Blade Opening Assist Mechanism

(71) Applicant: Benchmade Knife Co., Inc., Oregon City, OR (US)

(72) Inventor: Joe Cheung, Yongxiang (CN)

(73) Assignee: Benchmade Knife Co., Inc., Oregon City, OR (US)

(21) Appl. No.: 15/347,843

(22) Filed: Nov. 10, 2016

Related U.S. Application Data
(63) Continuation of application No. PCT/US2015/030269, filed on May 12, 2015.
(60) Provisional application No. 61/993,309, filed on May 15, 2014.

(51) Int. Cl. B26B 1/04

(52) U.S. Cl. CPC B26B 1/044

(57) ABSTRACT

A folding knife incorporates an opening assist mechanism that functions to drive the blade from the closed to the open position and to retain the blade in the closed position. In one embodiment a spring arm located to one lateral side of the blade interacts at its forward end with a drive pin on a tang portion of the blade during a part of the blade's rotational path. The spring arm applies pressure to the tang of the blade through the drive pin when the blade is closed

### FIELD OF THE INVENTION

This invention relates to knives equipped with mechanisms that provide an opening assist for the blade, and more particularly to a knife in which a spring member interacts with a drive pin on the blade during a portion of the blade's rotational movement to drive the blade to the open position.

### BACKGROUND

Most folding knives incorporate some kind of a mechanism that holds the blade or working implement safely in the closed position in which the sharp edge of the blade is held safely within the handle. There are many known mechanisms for retaining blades in the closed position, and there are obvious reasons why such mechanisms are used. Among other reasons, blade-retaining mechanisms prevent unintended opening of the knife and thus promote safety.

So-called “opening assist” mechanisms may also be incorporated into folding knives. Generally speaking, with a knife that incorporates an opening assist mechanism the blade is retained in the closed position with some kind of spring force, typically without the need for a latch or trigger. The opening assist function is provided by a spring mechanism that operates on the blade. As the user manually rotates the blade from closed toward the open position, the spring mechanism that acts on the blade reaches a threshold point. After the blade rotates beyond the threshold point the spring drives the blade to the open position. When the blade is in the closed position the spring mechanism holds the blade closed. When the blade is rotated past the threshold point, the spring drives the blade to open.

Knives equipped with opening assist mechanisms typically include some kind of locking mechanism to lock the blade open, and with many opening assist knives the same spring mechanism that drives the blade open also retains the blade closed.

For a variety of reasons, opening assist mechanisms have become very popular. For example, in appropriate circumstances and for appropriate users, there are many advantages to be derived from opening assist type of knives and many situations where such knives can be useful. These often include situations where the user has only one hand free. With the recent increases in popularity of opening assist knives there are many new types of mechanisms being developed.

There is always a need however for mechanisms that provide an automatic or opening-assist feature for knives.

### SUMMARY OF THE INVENTION

The present invention comprises a folding knife having an opening assist mechanism. The mechanism of the present invention uses a spring arm formed as an integral part of a plate on a lateral side of the blade; the spring arm interacts with and applies pressure to a pin on a tang portion of the blade during part of the blade's rotational path from closed to open, and from open to closed. Once a threshold point in the rotational movement of the blade is passed as the blade is moved from the closed toward the open position, the mechanism of the present invention rotationally drives the blade toward and into the fully open position. This is accomplished with the spring arm acting on the pin, which thereby imparts sufficient rotational kinetic energy to the blade that the inertia drives the blade into the fully open position. A locking mechanism locks the blade in the open position.

### BRIEF DESCRIPTION OF THE DRAWINGS

The invention will be better understood and its numerous objects and advantages will be apparent by reference to the following detailed description of the invention when taken in conjunction with the following drawings

FIG. 1 is a top plan view of a preferred embodiment of a folding knife according to the present invention, illustrating the knife with the blade in the closed position.

FIG. 2 is a side elevation view of the components of the knife shown in FIG. 1 in which the component parts are separated from one another in a view akin to an exploded view.

FIG. 3 is a side elevation view of the knife according to the present invention, illustrating the knife with the near-side handle sidewall removed to expose some internal components, and with the blade in the fully open and locked position.

FIGS. 4A through 4D are a series of sequential illustrations of the knife according to the present invention in which the near-side handle sidewall and the near-side liner are removed and wherein the blade is moving from the fully closed position (FIG. 4A) to the fully open position (FIG. 4D), and more particularly

FIG. 4A is a side elevation view similar to that of FIG. 3 showing the blade in the fully closed position.

FIG. 4B is a side elevation view in which the blade is beginning to be moved from fully closed toward the open position.

FIG. 4C is a side elevation view that is the next sequential view of the series of FIGS. 4A to 4D and illustrates the where the spring is driving the blade as it continues to move toward the open position.

FIG. 4D is a side elevation view similar with the near-side handle sidewall removed and showing the blade in the fully open and locked position

### DETAILED DESCRIPTION OF THE PREFERRED EMBODIMENTS

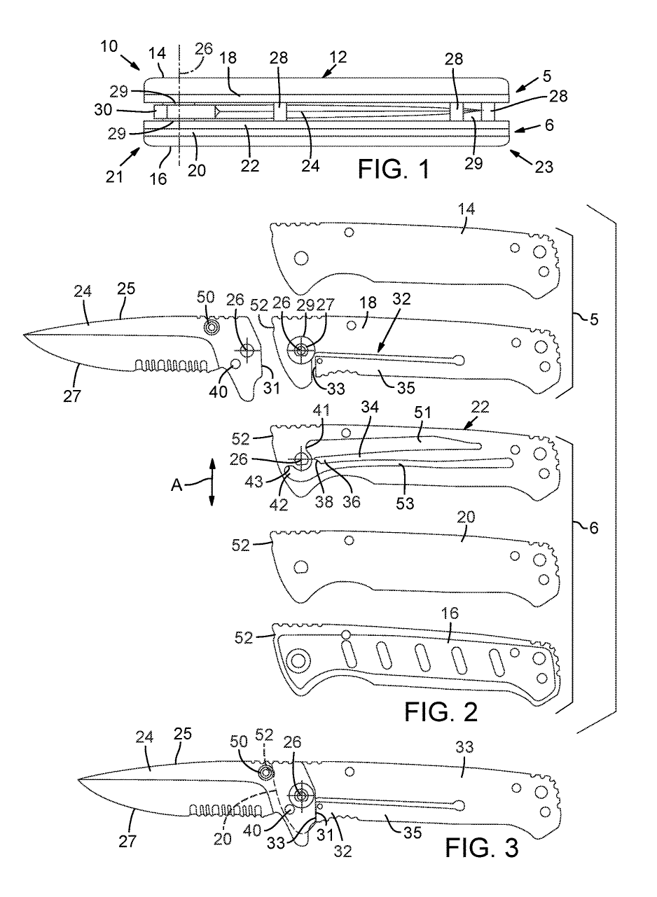

Folding knife 10 shown in FIG. 1 has an elongate handle 12 that is defined by separate handle halves that are identified generally with reference numbers 5 and 6. Handle half 5 is defined by an outer sidewall 14 and a liner 18 immediately adjacent to and inwardly of outer sidewall 14. Handle half 6 is defined by an outer sidewall 16, a liner 20 immediately adjacent to and inwardly of outer sidewall 16, and a spring liner 22 immediately adjacent to and inwardly of liner 20. A blade 24 is pivotally attached to the handle 12 at a pivot axis 26, which is toward one end of the elongate handle—referred to herein as the “forward” end 21 of handle 12. Other relative directional terms correspond to this naming convention: the “rear” or butt end 23 of the handle 12 is the end opposite the forward end 21; the “upper” edge 25 of blade 24 is the dull, non-working portion and the “lower” edge 27 of blade 24 is the sharpened, working portion; “inner” or “inward” refers to the structural center of the knife 10, and so on. FIG. 2 shows knife 10 with the blade 24 in the open position and the components in an exploded view. It will be appreciated that when the components are assembled into a finished knife 10 as illustrated in FIG. 1, the handle halves 14 and 16 are attached to one another in a conventional manner (such as with plural screws) with the blade pivotally attached to the handle halves 5 and 6 with a blade pivot pin that extends through pivot axis 26 and that is defined by a cylindrical pin that has its opposite ends in cooperatively shaped bores and receptacles in the handle halves. In the assembled knife 10, the handle halves 5 and 6 are held in a spaced apart relationship with spacers such as spacers 28 to define a blade-receiving groove 29 between the handle halves. The blade 24 is pivotally mounted so that the blade may be pivotally rotated about the blade pivot axis 26 between the open and closed positions as with a conventional knife. As used herein, the blade rotation plane is the plane that the blade travels through as it is rotated from closed to open, open to closed.

FIG. 2 is an exploded view of the knife 10 shown in FIG. 1 with the various components separated to better illustrate the components.

In FIG. 2 it may be seen that liner 18 incorporates a conventional liner locking mechanism identified generally with reference number 32. The liner locking mechanism works in a well-known manner such that the forward end 33 of the locking arm 35 and interacts with a locking surface 31 on the tang of blade 24 when the blade is in the open position to lock the blade 24 open. When the blade is in the closed position shown in FIG. 1 the locking arm 35 (which is not visible in FIG. 1) is biased toward sidewall 14.

Spring liner 22 is positioned immediately adjacent blade 24 in the assembled knife as shown in FIG. 1. With continuing reference to FIG. 2, the spring liner 22 includes a spring 34 defined by an elongate spring arm 36 formed in the liner. Spring liner 22 is preferably a unitary piece and is preferably a resilient metal such as spring steel. As such, the spring arm is preferably cut from the unitary piece that defines the liner—as shown in FIG. 2 there is an elongate void 51 cut above spring arm 36 and an elongate void 53 cut from the spring liner 22 below the spring arm. This defines the spring arm 36 as having a free end, referred to as forward tip 38, which is movable in the plane defined by the spring liner 22, and an opposite end that in the embodiment of FIG. 2 is integral with the rest of the material that makes up the spring liner. It will be appreciated that the spring arm 36 could be a separate piece that has one free end 38 and in which the opposite end is fixed to the spring liner. In FIG. 2 the spring arm 36 is shown in its resting, unbiased position shown and the movement of its forward end 38 is illustrated with arrow A. In this position the spring arm is at rest and under no spring pressure. However, as detailed below, the forward tip 38 of the spring arm interacts with a drive pin 40 that extends from the tang portion of the blade 24 during part of the blade's rotational path moving from closed to open, and open to closed, and thereby applies biasing force to the blade. As noted, the spring arm 36 is cut from the material that is used to form the spring liner 22, as illustrated, which is preferably a unitary piece but which could be formed in multiple pieces.

Blade 24 includes a drive pin 40 that is cylindrical and which extends outwardly from a lower portion of the tang, forward of the pivot axis 26 as shown in FIG. 2. Forward of pivot axis 26 but above the pivot axis is a thumb lug 50, which also is attached to and extends from the blade 24. The thumb lug 50 may be used to assist opening and closing the blade in known operational manners, and as shown in FIG. 3, also serves as a blade stop when the blade is in the fully open position when the thumb lug abuts a shoulder 52 on the forward end of the assembled handle half 6.

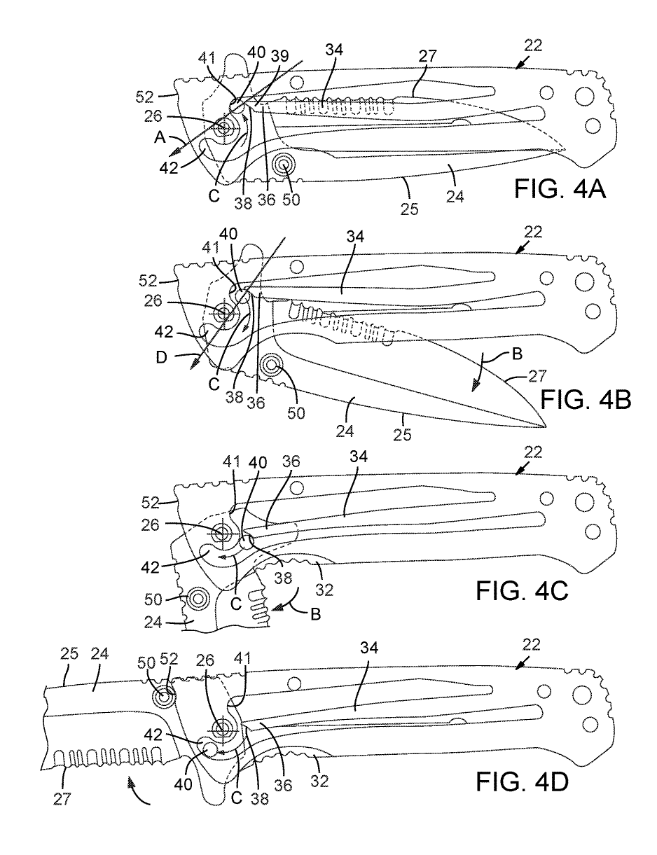

Reference is now made to the series of drawings of FIGS. 4A through 4D in order to illustrate operation of the knife 10, and more particularly, how the spring arm 36 operates on the drive pin 40 during a portion of the blade's rotational path and when the blade is in the closed position. In the FIG. 4 series the handle half 6, namely, sidewall 16 and liner 20 are removed to illustrate the spring liner 22 and the spring arm 36.

The drive pin 40 is preferably a cylindrical pin. Accordingly, the forward end 38 of spring arm 36 that interacts with the drive pin is preferably defined by a curved section or surface 39 that is cooperatively shaped so that the forward, curved section 38 interacts with the cylindrical outer surface of pin 40. The spring liner 22 includes an arcuate or semi-circular channel 42 that extends around the pivot axis 26 from an upper end 41 of the arcuate slot that is above and behind the pivot axis to a forward end 43 of the slot that lies ahead of and below the pivot axis 26. In the preferred embodiment the arcuate slot extends through about 180 degrees to allow the blade to rotate fully between closed and open positions, but the length of the slot may vary. The arcuate slot is essentially an extension of the void 53 in liner 22 and which extends around the pivot axis 26. The drive pin 40 extends away from blade 24 a sufficient distance that the pin extends into the arcuate channel 42 of spring liner 22, but does not touch the adjacent liner 20 in the assembled knife. In FIG. 4A the blade 24 is shown in the fully closed position. In this position the curved section 39 of forward end 38 of spring arm 36 extends into the arcuate slot 42 and is in contact with drive pin 40 and the spring 34 is biased upwardly and is applying significant pressure to drive pin 40 and thus blade 24 to the closed position. With the blade 24 in the closed position, the energy applied to blade 24 by spring arm 36 is “stored energy” since the blade is in a pre-threshold point of rotation. In other words, the force applied to the drive pin 40 by spring 34 is generally in the direction indicated by the vector defined by arrow A. The spring 36 is thus exerting pressure to blade 24, through pin 40, in a direction that causes the blade to remain in the closed position. The blade will not rotate on its own under this force since the force vector, arrow A, is pushing the drive pin in a rotational path of the blade around the pivot axis 26 toward the closed position.

Turning to FIG. 4B, which is the next sequential illustration, blade 24 is shown at an intermediate point in its rotational path, either from closed to open or from open to closed. As noted above, an opening assist function is provided by operation of spring 34 on blade 24 as the user manually rotates the blade from closed toward the open position. Once the blade rotates past a threshold point the force applied to the blade by the spring is applied in a direction such that the blade is pushed toward the open position rather than toward the closed position. After the blade rotates beyond that threshold point the spring drives the blade to the open position. On the other hand, when the blade is in the closed position the spring is pushing on the blade in a direction that causes the blade to be held in the closed position.

With reference to FIG. 4B and considering the situation of blade 24 being rotated from closed toward open (i.e., the blade is rotating in the clockwise direction in FIG. 4B-arrow B, FIG. 4B). As the blade rotates, drive pin 40 is rotating through the arcuate slot 42 (arrow C, FIGS. 4B and 4C) and at the point of rotation shown in FIG. 4B the curved section 39 of forward end 38 of spring arm 36 is in contact with drive pin 40 and the blade 24 is at or near the threshold point in its closed-to-open rotational path. The energy stored in spring 34 is being applied to blade 24 through drive pin 40. The curved section 39 of spring arm 36 is cooperatively shaped so that when the spring arm is in contact with the drive pin 40, which is cylindrical, relative movement between the drive pin and the spring arm is made smoother.

In the next sequential illustration of FIG. 4C, blade 24 has been rotated from the position shown in FIG. 4B further in the clockwise direction, arrow B, toward the open position. This position of blade 24 is such that the blade has moved past the threshold point and the blade is free to rotate freely toward the open position under the force applied to the blade by the spring 34. It may be seen that forward end 38 of spring arm 36 is either no longer in contact with drive pin 40 or just at the point where the forward end is no longer in contact—hence, FIG. 4C does not include a force vector arrow. The blade is free to continue its rotational path about pivot axis 26 toward the open position and as it rotates, drive pin 40 rotates through arcuate channel 42.

Once the blade 24 has passed through the threshold point in its rotational path from closed toward open, the vector of the force (arrow D, FIG. 4B) that is applied to the blade by spring 34 against drive pin 40 has changed as the spring arm 36 rapidly moves from its loaded position (FIG. 4A) to its resting position (FIG. 4D). As the blade 24 thus rotates, the stored energy of the spring 34 is applied to the blade 24 through drive pin 40, causing the blade to rotate quickly and freely toward the open position, which is shown in FIG. 4D. Once the forward end 38 of the spring arm 36 is out of contact with drive pin 40, the spring 34 is again in its resting, unloaded position and the blade 24 rotates freely toward open under the inertia or momentum that has been imparted to the blade by the spring.

When the blade reaches its fully open position, thumb lug 50 abuts shoulder 52 on handle half 6, which defines an open-stop that stops rotation of the blade. Simultaneously, the liner locking mechanism 32 locks the blade in the open position. More specifically, although not shown in FIG. 4D, the forward end 33 of the locking arm 35 slips behind the locking surface 31 on the tang of blade 24 to lock the blade 24 in the open position. In this position, spring arm 36 is at rest and the forward end 38 is not in contact with the drive pin 40.

To rotate blade 24 from the open position of FIG. 4D to the closed position, the liner locking mechanism is first unlocked in the conventional manner so that the blade is free to rotate toward closed. The blade rotates freely in the counterclockwise direction in the FIG. 4 series until the forward end 38 of spring arm 36 begins to making contact with drive pin 40—that is, at approximately the position shown in FIG. 4C. At this point force must be applied to the blade to continue its rotation from open to closed in order to overcome the counteracting force being applied to the blade by spring 34 (through its contact with drive pin 40). Continuing rotation of blade 24 in the counterclockwise direction results in the blade moving once again past the threshold point in its rotational path and rotation of the blade causes the drive pin 40 to force the spring arm 36 back into its fully biased, loaded position. Returning to FIG. 4B and again assuming that the blade is moving in the counterclockwise direction, the blade is at or near the threshold point in its rotational path. Once the threshold point is passed, continued rotation of the blade 24 toward closed will cause the force applied to the blade by spring 34 to move the blade under spring force into the closed position—the spring causes the blade to “snug” into the closed position. The spring 34 retains the blade closed due to the direction of the force applied to drive pin 40. The blade will not be moved into the open position until a user initiates rotation from closed to open, moves the blade past the threshold point, at which time the force applied to the blade drives the blade fully open and locked, as detailed above.

Operation of the opening assist mechanism will now be detailed. It will be appreciated that in the assembled knife 10 the spring arm 34 is positioned laterally to the side of the blade 24 and does not interfere with the blade as it moves from the closed to open position, and back. The spring arm thus moves in a plane that is defined by the plane of spring liner 22 and which is laterally to the side of the plane defined by the blade, parallel to the plane of blade rotation. The spring liner 22 and the spring arm 36 do not interfere with movement of the blade. In FIG. 2 the direction of movement of the forward tip 38 of spring arm 36 is illustrated with arrow A. With blade 24 stowed in the closed position such that working edge of the blade is safely held within the handle 12, spring arm 36 is deflected from its resting position and is therefore applying substantial spring force to the blade through drive pin 40. That is, the spring 34 is “loaded.” The direction of the force applied to the blade by the spring arms through the drive pin (shown generally and schematically with the vector arrow A in FIG. 4A), and the geometric relationship between the blade pivot axis 26, and the position of drive pin 40 relative to the pivot axis 26 is such that blade 24 is held in this closed position by the spring force applied to the blade. Stated another way, the pressure applied to blade 24 by the spring arm 36 is applied in a direction that is slightly forward such that the force vector from the point at which the spring arm contacts the drive pin is slightly in the forward direction, toward pivot shaft 26, causing the blade to be firmly retained closed. It will be appreciated nonetheless that the blade is under significant potential energy applied by spring arm 36 through drive pin 40.

Typically, the blade is rotated from the closed position to the open position by the user applying pressure to the exposed spine of blade 24. Alternately, pressure may be applied to thumb lug 50. As the blade is rotated toward open, drive pin 40 rides along the curved section 39 at the forward end 38 of spring arm 36, which further deflects the spring arm 36 to thereby load the blade with even greater potential energy. As noted above, as rotation of the blade continues, a threshold, which also may aptly be described as a kind of top dead center point, is reached (e.g., FIG. 4B).

As the blade reaches the threshold point in its rotational path and as the user continues rotation of the blade away from the closed position, the vector of the spring force changes direction from arrow A, FIG. 4A, to arrow D, FIG. 4B, such that the force vector is below the pivot axis 26. At this point, once the threshold point is reached the spring arm 36 rapidly moves from its loaded state to its resting position (FIG. 4C, 4D). As the blade thus rotates, the stored energy of the spring 34 is applied to the blade 24 through drive pin 40, causing the blade to rotate freely and quickly toward the open position where it automatically locks when thumb lug 50 abuts shoulder 52. This spring force acting on the blade imparts rotational kinetic energy to the blade, and any and all pressure applied by the user to thumb lug 50 may be released once the top-dead-center point is passed, and the blade is automatically driven into the open position under the spring force of the spring arm. Thus, as the spring arm 36 snaps to its normal resting, or “unloaded” position, the blade is quickly and positively driven to the open position. The spring arm thus imparts sufficient energy to the blade that the inertia of the blade carries it into the open position.

There is therefore a threshold point in the pivotal rotation of blade 24 from the closed to the open position beyond which the spring arm supplies all of the energy necessary to move the blade into the fully open (and locked) position. In the preferred embodiment, the threshold position is the point in the rotation of the blade where the forward end 38 of spring arm 36 imparts a force vector that drives the blade toward the fully open position in the manner described. If the blade is not rotated to this threshold point, the spring arm causes the blade to remain in the closed position.

It will be appreciated that force must be applied to blade 24 to move it back from its open position to the closed position since the resilient biasing force of spring arm 34 is acting against this motion, essentially urging the blade back into the closed position.

While the present invention has been described in terms of a preferred embodiment, it will be appreciated by one of ordinary skill that the spirit and scope of the invention is not limited to those embodiments, but extend to the various modifications and equivalents as defined in the appended claims.

1. An opening assist mechanism for a folding knife, comprising,
a handle having first and second handle halves held in a spaced apart relationship to define a blade-receiving groove therebetween and wherein the first handle half is defined by an outer sidewall and a liner adjacent thereto, and the second handle half is defined by an outer sidewall, a first liner adjacent to the outer sidewall and a second liner adjacent to and inward of the first liner, the second liner defining a second liner plane;
a blade pivotally connected between the handle halves at a tang and rotatable about a pivot axis between an open position and a closed position;
a spring arm in the second liner, said spring arm having a free forward end and a fixed end wherein the free forward end of said spring arm is movable in the second liner plane, and an arcuate slot in said second liner, said arcuate slot extending from a first end located above said pivot axis, around said pivot axis to a second end located below said pivot axis;
a drive pin attached to and extending from the tang portion of the blade so that a longitudinal axis of said drive pin extends transversely to the second liner plane and said drive pin extends into said arcuate slot, said drive pin operatively positioned on said tang portion so that said drive pin is adjacent said free forward end of said spring arm so that said spring arm applies force to said drive pin during part of the blade's rotational path from a closed position to an open position.

2. The opening assist mechanism according to claim 1 wherein said spring arm applies force to said drive pin to retain said blade in the closed position.

3. The opening assist mechanism according to claim 2 wherein said spring arm is in contact with and applies force to said drive pin when said blade is rotated from its closed position to a threshold point and wherein when said threshold point is passed the blade is driven to the open position by force applied to said blade by said spring arm.

4. The opening assist mechanism according to claim 1 wherein said liner in the first handle half comprises a lock arm.

5. The opening assist mechanism according to claim 1 wherein the spring arm is integrally formed in said second liner.

6. The opening assist mechanism according to claim 1 in which said drive pin is cylindrical and the free forward end of said spring arm defines a curved surface that is cooperatively shaped to interact with the cylindrical drive pin.

7. The opening assist mechanism according to claim 6 in which the spring arm applies force to said drive pin when said blade is in said closed position to retain said blade in said closed position, and wherein when said blade is rotated past a threshold point between said closed position and said open position, said spring arm drives said blade into the open position.

8. An opening assist mechanism for a folding knife, comprising,
a handle having first and second handle halves held in a spaced apart relationship to define a blade groove therebetween,
a blade pivotally connected between the handle halves at a tang and movable between an open position and a closed position, said blade movable in a blade plane between the open and closed positions;
a spring arm located on one lateral side of the blade, said spring arm having a fixed end and a free end and said spring arm movable in a spring arm plane that is parallel and lateral to said blade plane;
a drive pin defining an axis and extending from the tang such that the drive pin axis is normal to the spring arm plane, and said drive pin operatively positioned on said tang such that the free end of said spring arm applies force to said drive pin.

9. The opening assist mechanism according to claim 8 wherein the second handle half further comprises a sidewall and a liner adjacent said sidewall, and wherein said spring arm is integrally formed in said liner and movable in the spring arm plane from a first, loaded position to a second, unloaded position.

10. The opening assist mechanism according to claim 9 in which the free end of the spring arm contacts the drive pin when the blade is in the closed position.

11. The opening assist mechanism according to claim 10 in which the free end of the spring arm exerts pressure on the drive pin in order to retain said blade in the closed position under spring force.

12. The opening assist mechanism according to claim 11 wherein when said blade is moved from the closed position toward said open position the free end of the spring arm is in contact with said drive pin and said blade reaches a threshold point in the rotational path after which said spring arm returns to its second, unloaded position and thereby drives said blade to said open position.

13. The opening assist mechanism according to claim 9 in which said liner further comprises an arcuate slot extending at least partially around said pivot axis.

14. The opening assist mechanism according to claim 13 wherein said drive pin extends into said arcuate slot in said spring liner.

15. The opening assist mechanism according to claim 14 in which said drive pin is cylindrical and the free end of said spring arm defines a curved surface that is cooperatively shaped to interact with the cylindrical drive pin during relative movement between the free end of said spring arm and said drive pin.

16. An opening assist mechanism for a folding knife, comprising:
a handle having first and second handle halves held in a spaced apart arrangement to define a blade slot therebetween, wherein the first handle half comprises a first outer side wall member and a first liner located inwardly of the first outer side wall member, and the second handle half comprises a second outer side wall member and a second liner located inwardly of the second outer side wall member;
a spring adjacent the second liner, said spring having a forward end that is movable in a spring plane between a first position and a second position;
a blade pivotally attached at a tang portion to the handle and movable in the blade slot about the pivotal attachment between closed and open positions to define a plane of blade rotation that is parallel to and laterally offset from the spring plane;
a pin attached to the tang and extending therefrom in a direction transverse to the blade plane, said pin extending into the spring plane;
wherein when said blade is in the closed position said forward end of said spring is in the first position and said spring retains said blade in said closed position, and wherein said spring is operable to drive said blade to said open position when said spring moves from said first position to said second position.

17. The opening assist mechanism according to claim 16 wherein said forward end of said spring is in contact with said pin when said blade is in the closed position.

18. The opening assist mechanism according to claim 17 wherein said forward end of said spring is in contact with said pin during only a portion of the rotation of said blade from the closed to the open position.

19. The opening assist mechanism according to claim 18 in which said spring is defined by an elongate arm formed in a third liner that is located inwardly of the second liner.

20. The opening assist mechanism according to claim 19 wherein the forward end of said spring arm defines a curved surface.
